(19) United States
(12) Patent Application Publication
(10) Pub. No.: US 2011/0313932 A1
(43) Pub. Date: Dec. 22, 2011

(54) MODEL-BASED PROJECT NETWORK

(75) Inventors: Manisha D. Bhandar, Yorktown Heights, NY (US); Pankaj Dhoolia, Uttar Pradesh (IN); Anca A. Ivan, San Jose, CA (US); Juhnyoung Lee, Yorktown Heights, NY (US); Senthil Kk Mani, Haryana (IN); Debdoot Mukherjee, Kolkata (IN); Aubrey J. Rembert, Hawthorne, NY (US); Gerhard Sigl, Bedford, NH (US); Vibha S. Sinha, New Delhi (IN); Biplav Srivastava, Noida (IN)

(73) Assignee: INTERNATIONAL BUSINESS MACHINES CORPORATION, Armonk, NY (US)

(21) Appl. No.: 12/818,811

(22) Filed: Jun. 18, 2010

(51) Int. Cl. G06Q 10/00; G06F 17/30

(52) U.S. Cl. 705/301; 705/348; 707/784; 707/E17.059

(57) ABSTRACT

One or more project profiles, one or more people profiles, one or more work product profiles are created and connections are made among the one or more project profiles, one or more people profiles, and one or more work product profiles that form a network of projects, people, work products and others. A profile database stores the network of the one or more project profiles, the one or more people profiles, the one or more work product profiles. Data stored in the profile database is analyzed and one or more people, work products and projects that are related to current project are recommended for use in the current project.

### FIELD

The present disclosure relates generally to computer systems, network and applications and more particularly to a model-based project network. Additionally, the disclosure is related to Information Technology (IT) consulting services, e.g., IT system integration services, packaged application software configuration, installation and upgrade services where the reuse or use of assets from previous best practices provides benefits, for instance, in terms of cost reduction and quality improvement.

### BACKGROUND

Projects such as software, engineering or packaged application projects can get large involving many components and people, and may last for several years. Further, there can be a large number of such projects in progress at any point in time and also projects that are inactive or have been completed. Those projects may have produced and used many artifacts or items, which for example, in addition to the final products for delivery to the customers, may include components that are non-deliverables, e.g., intermediary components used in the project.

Project artifacts that are not project deliverables such as documents, computer program code, checklists, calendars, presentations, spreadsheets, processes, video, audio, wikis, blogs, and schedules are generally not shared between projects. For example, packaged application projects are isolated from one another and there is no automatic way of discovering and connecting to other, potentially useful projects. Briefly, “packaged application” projects include projects for deploying software modules associated with a packaged application or a suite of software. For example, enterprise resource planning (ERP) applications such as SAP™, Oracle™ and others may be deployed on a company's infrastructure, system and/or the like. No standard way is available to share information between active projects, and no standard mechanism is available to use or reuse non-deliverables from inactive projects. Also, project participants are not always aware of the roles of other project participants within their project and across other projects. Generally, it is difficult to understand the interdependencies between projects, whether active or inactive.

### BRIEF SUMMARY

A system and method for managing a model-based project network are provided. In one aspect, the system may include a network creation module operable to create one or more project profiles, one or more people profiles, and one or more work product profiles, and a plurality of links among said one or more project profiles, said one or more people profiles, and said one or more work product profiles. The system may also include a profile database operable to store said one or more project profiles, said one or more people profiles, and said one or more work product profiles, and said plurality of links. A network analysis module may be operable to analyze data stored in the profile database and recommend one or more people, work products and projects that are related.

A method for managing a model-based project network, in one aspect, may include creating a project profile that includes information associated with a project and identifying a people profile associated with a possible participant for the project by searching a database of profiles and analyzing data stored in the database of profiles. The method may also include identifying a work product profile from the database of profiles for use in the project based on the data stored in the database of profiles, the work product profile including information associated a work product and work product content. The method may further include creating a project-to-people link between the project profile and the identified people profile; and creating a project-to-work product link between the project profile and the identified work product profile.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a model-based project network method in one embodiment of the present disclosure.

FIG. 2 is an architectural diagram illustrating functional components of the model-based project network in one embodiment of the present disclosure.

FIGS. 3A, 3B, 3C and 3D illustrate examples of the network of the present disclosure.

FIG. 4 illustrates an example of a computer system, in which the systems and methodologies of the present disclosure may be carried out or executed.

### DETAILED DESCRIPTION

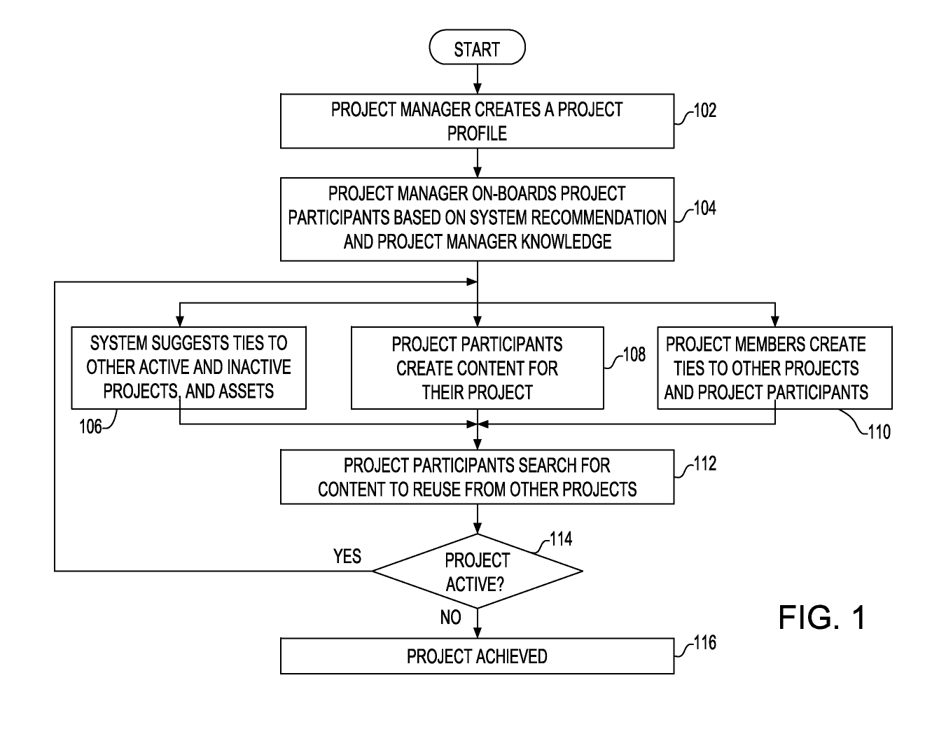

FIG. 1 is a flow diagram illustrating a model-based project network method in one embodiment of the present disclosure. At 102, a project manager may create a project profile. A project profile is also referred to as a node. A node exists in a network of nodes. An edge connects a node to another node. Creating a project profile may include creating a project home page, and entering information associated with the project. The information may include, but is not limited to, the dates associated with the project, for instance, start date (and/or time) of the project, estimated duration, estimated milestones of the progress in the project, and other dates, information about the customer for whom the project is directed, the consumer product industry to which the project is directed, and other information.

The project profile is created in a network, for example, that resembles a social network, and which connects a plurality of projects, people and work products. The project profile may be created in Web environment and stored in a profile database.

At 104, the project manager or the like identifies project participants, for example, based on system recommendation and/or the project manager's knowledge. For instance, based on the information entered for the current project, a processing logic of the present disclosure may look up in the profile database and suggest team member or persons who may have past experiences or qualifications appropriate for the current project. The project participants may include programmers, engineers, designers, managers, product and customer support personnel, sales personnel and others.

At 106, also based on the information entered for the current project, the processing logic of the present disclosure may also suggest automatically, ties or connections (also referred to as links) to other active and inactive projects and work products. For example, the processing logic of the present disclosure may search the database for other projects, people and work products that share some common attributes with the current project. Various ranking algorithms may be utilized to rank the other projects to the current project, for instance, by closeness in various attributes the projects share in common. Techniques such as link prediction and link-based node ranking algorithms may be utilized. Briefly, link prediction is a branch of Relational Learning which is concerned with models of domains that exhibit both uncertainty (which can be dealt with using statistical methods) and complex, relational structure. Typically, the knowledge representation formalisms developed in Relational Learning use (a subset of) first-order logic to describe relational properties of a domain in a general manner (universal quantification) and draw upon probabilistic graphical models (such as Bayesian networks or Markov networks) to model the uncertainty; some also build upon the methods of inductive logic programming.

Common approaches of Relational Learning include collective classification, i.e., the (simultaneous) prediction of the class of several objects given the objects' attributes and their relations; link prediction, i.e. predicting whether or not two or more objects are related; link-based based clustering, i.e., the grouping of similar objects, where similarity is determined according to the links of an object, social network modeling, and object identification/entity resolution.

Another related art is Nearest Neighbor Search (NNS), also known as proximity search, similarity search or closest point search, which is an optimization problem for finding closest points in metric spaces. Various solutions to the NNS problem may utilize linear search, space partitioning, locality sensitive hashing, and others. The quality and usefulness of the algorithms are determined by the time complexity of queries as well as the space complexity of any search data structures that are to be maintained.

At 108, project participants create content of the project. For example, work products such as working documents may be created. Such documents may include but are not limited to a product process definition document that defines product process or procedure, user requirement document that describes requirements of a specific customer, gap document that describes a gap between what is required by the customer and what that customer currently has, for instance, in terms of system hardware, software, and others. In addition a separate node or profile may be created in the network for the work product or a set or group of work products. The node or profile may include information about the work product and a link to a storage location or device where the actual work product (e.g., the document content, computer program code) is stored and from where the work product may be retrieved. Thus, for example, a work product node or profile may include information describing the work product, e.g., the author, what the work product is, what the work product can be used for, and other information, and a hyperlink, for example, which when selected enables downloading or access to the actual content of the work product. The work products may be also considered as project resources, for example, documents, computer program code, checklist, presentations, audio, video, meeting minutes, calendars, which for instance, may be stored in a digital form on a storage or memory device. Thus, the project participants or team members may create, store and tag those work products for the current project.

At 110, ties or connections are created from the current project to other projects and project participants, for instance, based on the suggestions identified at 106. The ties or connection may be created, for example, by associating or linking the current project to other projects (a project to project link), project participants (a project to people link), and work products (project to work product link) in a database that stores information about all nodes or profiles in the network.

At 112, project participants may search the network for content to use or reuse from other projects. For example, a database may be searched to find other projects, work products and people that have one or more common attributes related to the current project. The database may be searched also using the ties and connections, i.e., finding other projects, work products, and people that are tied to the current project, directly or indirectly by tracing the links or connections. In this way, a network (for example, like a social network) of projects, work products, and people may be created and used to find other related projects, work products, and people, so for example, projects may share common work products and people.

In one aspect, after the work product is identified from other projects that may be used or reused for the current project, the work products may be cleansed, for instance, stripped or cleaned of any security, confidential or privacy related information or customized information, before being reused for the current project. In this way, privacy, confidentiality, or security of information may be preserved across the projects, while yet allowing for sharing of the resources between the projects.

At 114, while the project remains active, steps 106, 108, 110, and 112 may be repeated. That is, more related projects, work products and people may be identified from the network, more work products created and more connections or links may be created between the current project and other nodes in the network.

At 116, the current project along with the its work product, information about the people who worked on the project and other information are archived or stored in a storage device, for example, for reuse by other projects.

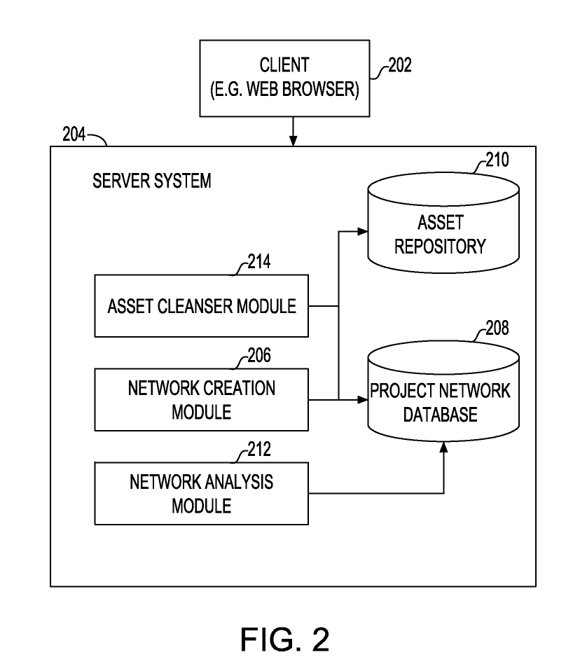

FIG. 2 is an architectural diagram illustrating the functional components of the model-based project network in one embodiment of the present disclosure. A client 202 may include user interface logic such as a web browser executing or running on a device that includes one or more processors and memory, and communicating with a server system 204, for instance, to achieve the functionalities described above with reference to FIG. 1.

The client 202 provides a user such as the project manager an ability, for instance, in a form of a user interface for inputting information for creating a node in a network, for instance, information about a project to create a project profile or node, information about one or more work products to create a work product profile or node, information about a team member or a group of team members to create a team member or people profile or node.

The server system 204 may be a computer system including one or more processors, memory, storage, and network interfaces and programming logic. The server system may have other device components such as peripheral devices and interfaces. A network creation module 206 may be a processing module or logic executing on the server system 204 that for example, functions to create a node or profile based on the input from the client 202 and store the created node or profile in a project network database 208. The actual work product, e.g., documents and contents created, are stored in the asset repository 210.

A network analysis module 212 makes recommendations as to the work products that are frequently used together, users that work well together, and other information based on the information stored in the project network database 208. The recommendations may be suggested, for example, by performing searches on the data stored in the database 208 to determine nodes that have certain features in common, or nodes that have features in common with the current node or profile that is being created. Those nodes or profiles, which may represent people, work product or other projects suggested by the network analysis module 212, may be selected by the user at the client 202 and linked to the current project profile or node (or current node or profile of work product or people) being created. The link (or connection or tie) may be created by associating those node or profiles to the current node or profile being created in a data structure, for example, database table.

The network analysis module 212 also may apply link mining (e.g., ranking, prediction, clustering, subgraph discovery) techniques to assist with building the network using existing links and nodes (e.g., project profiles, people profiles, work product profiles). In this way insight for effective and efficient use of network may be gained based on network structure, node attributes, and link attributes.

An asset cleanser module or functionality 214 deletes private or sensitive information from the work products in the asset repository 210 when exposing or allowing those work products to be reused by other projects. Examples of private or sensitive information may include company name, trade names, and other confidential information. The cleanser module 214 may also hide links that are deemed to be private or confidential. Thus information may be disclosed selectively to preserve privacy of the users in the networked environment.

Project network database 208 may store tables of information about the created projects, information about the people who worked on the projects, information about the work products involved or used in the projects. Each of the different projects, people and work products or groups of work products may be represented as a node in a network. Thus, the database 208 may have a project node table, a people node table, and work product node table. Each row of the project node table may include a name, title, and/or another identifier of the project, corresponding people who worked on the project and corresponding one or more work products used for the project. The project node table may be indexed by the project name or identifier. The project node table may store other information. Similarly, each row of work product node table may include a name, title, and/or another identifier of the work product or a group of work products, corresponding one or more projects that the work product was used for, and corresponding people who created or used the work product. The work product node table may be indexed by the work product name or identifier. The work product node table may store other information. Likewise, each row of people node table may include a name, title, and/or another identifier of the people or a group of people (e.g., team), corresponding one or more projects that the people worked on or otherwise were involved with, and corresponding work product or work products the people created, used, and/or otherwise was involved with. The people node table may be indexed by the people name or identifier. The people node table may store other information.

The links (connections or ties) between the nodes (e.g., project, work product and people) may be created by updating the appropriate node tables in the social network database. For instance, a new project entry may be created in the project entry table as a new row with the new project identifier and corresponding columns that include one or more other projects, work products and people connected to new project. The columns specifying the associated nodes may be in the form of a reference pointer or value as would be understood by those skilled in the computer technology. For instance, an entry that specifies a work product in a node table may include a reference pointer or memory location or address of the location in the asset repository where the particular work product is stored. It should be understood that any other data structures or ways of representing the nodes and the network of links among the nodes may be utilized, and the present disclosure does not limit the data representation to any specific form.

The asset repository 210 stores work products, for example, documents describing the projects, business process definition documents, gap documents, user requirement documents and other documents related to the project. The content of the documents may be in a plain text format, extended markup language (XML) format, and/or stored in an objected oriented format, for example, with each partitionable section of a document being represented as a data structure object.

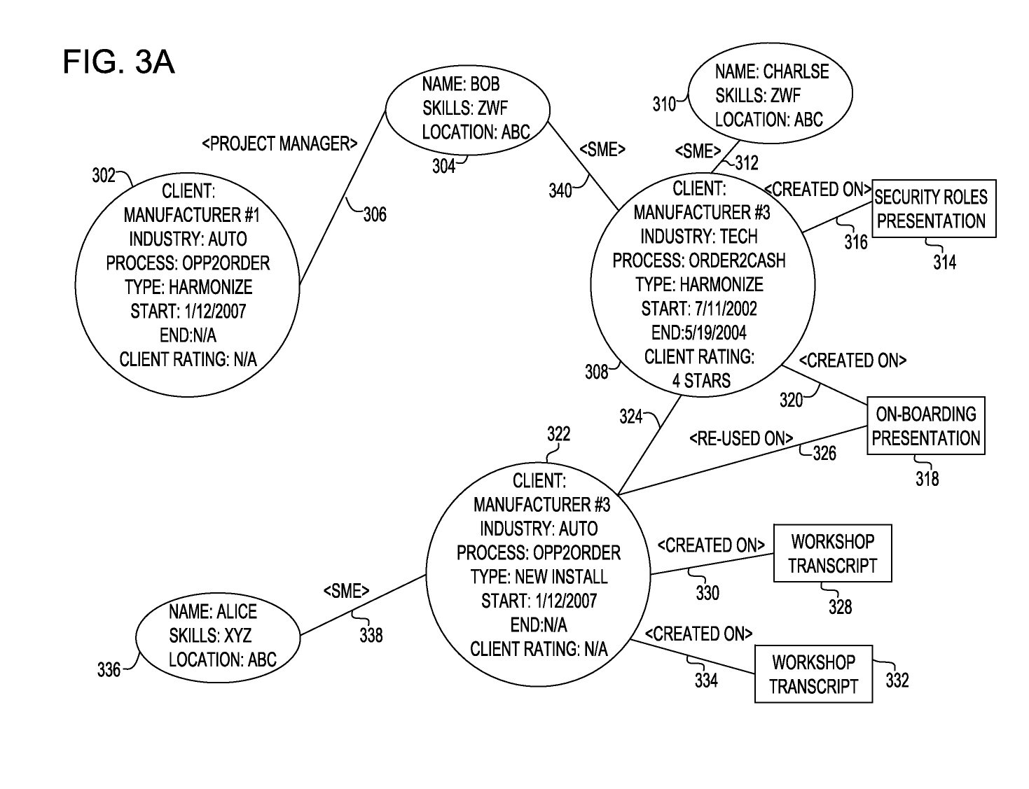

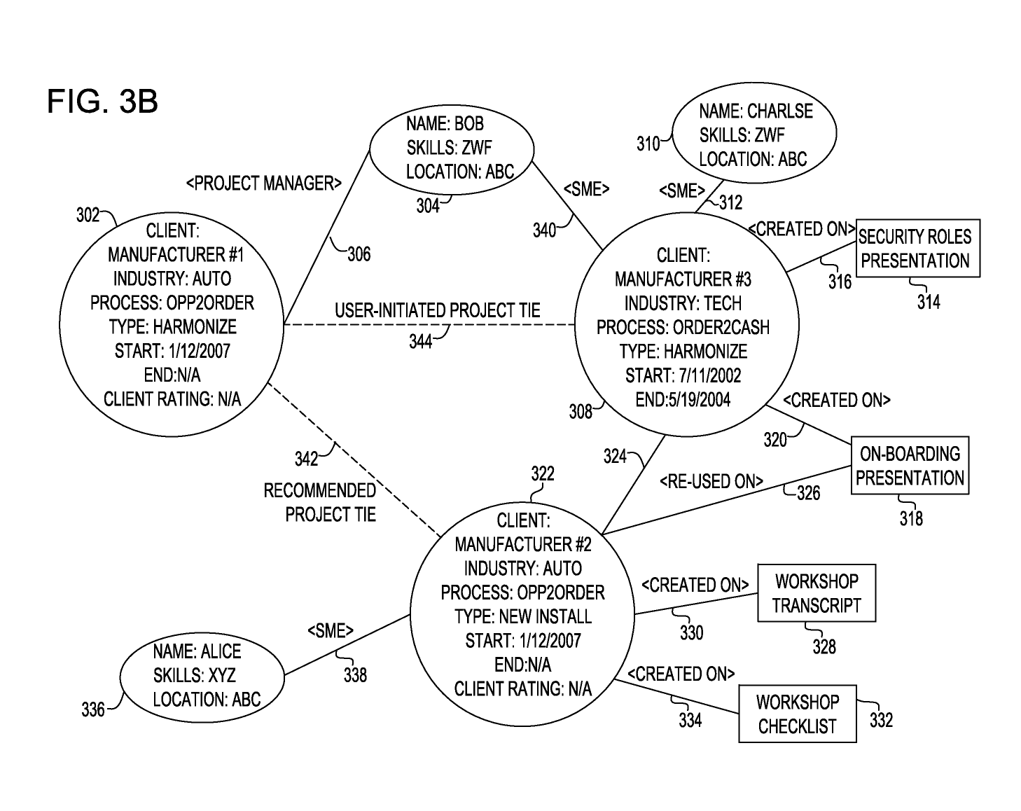

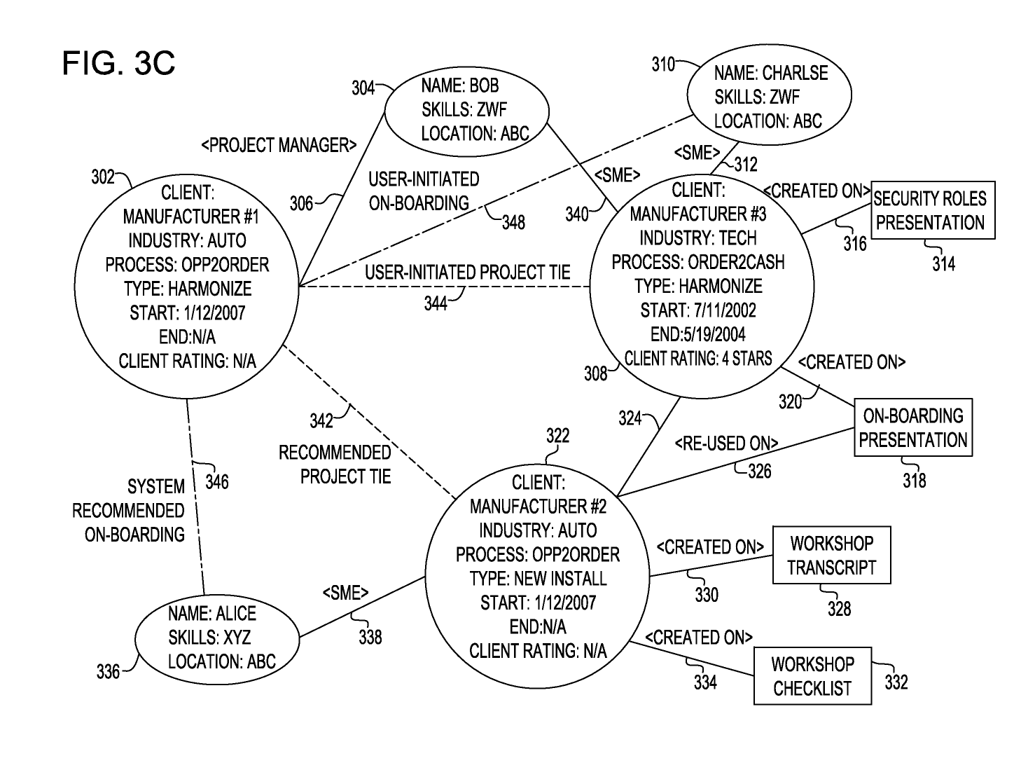

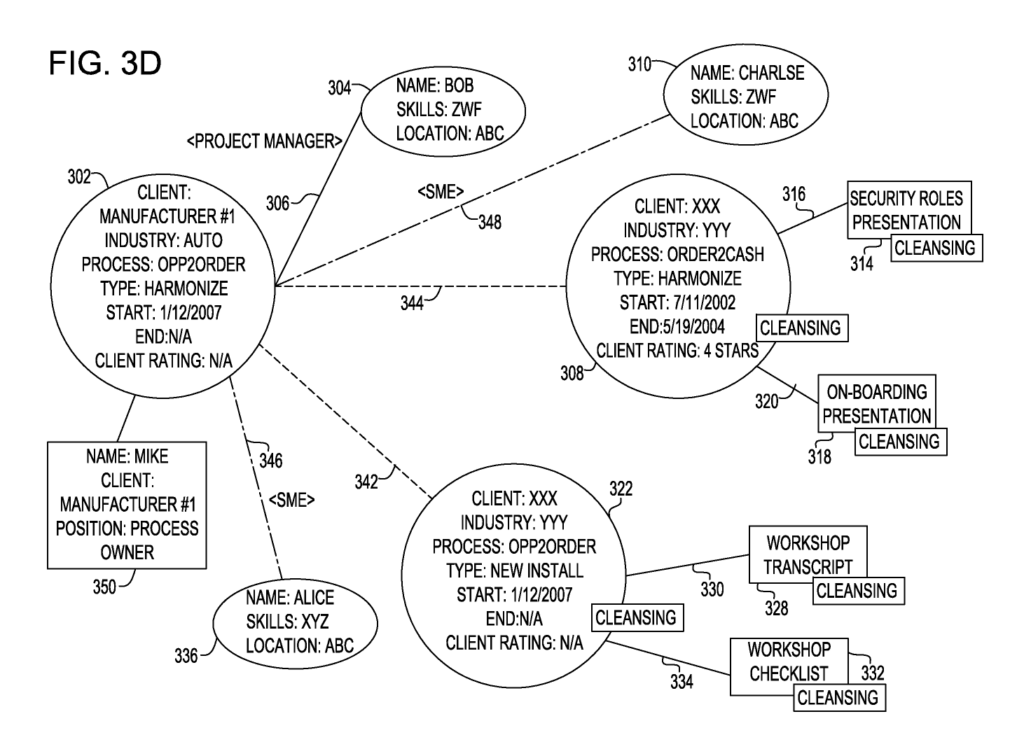

FIGS. 3A, 3B, 3C and 3D illustrate examples of the network of the present disclosure. A network includes a plurality of profiles or nodes and links connecting one or more of the plurality of profiles or nodes. In this description, the terms profile and node are used interchangeably. Each profile or node has information about the node and may be connected to one or more other profiles or nodes to form a network of profiles or nodes. The terms link, connection, and tie are also used interchangeably. A link, connection, or tie may be categorized into different types, which may specify or indicate the type of a relationship between the nodes. As described above, the nodes and links may be implemented and stored as a table structure in a database.

In the example shown in FIG. 3A, a project profile or node 302 may be created (referred to herein as the current project), for instance, by a project manager. Creating a profile or node may be comparable to creating a profile on a social networking website such as Facebook®. The project manager may already have a people profile or node 304 representing the project manager in the network. A link 306 is created between the current project node 302 and the project manager's people node 304. The link type may be specified as “project manager”. The link 306 may be created automatically as default, for example, by the network creation module shown in FIG. 2 since the module would know that the user of the people node 304 created the current project node 302. This automatic or default link may be modified or overridden manually. As an example of underlining data structure that represents the newly created project node 302, a new entry may be created in a project node table of the social network database (e.g., shown in FIG. 2 at 208). Information about the current project node and one or more links to other nodes may be stored the database also.

FIG. 3A also shows other existing nodes and links of the network. For instance, a project node 308 exists which is created for client of “Manufacturer #3” whose industry is in technology sector and so forth as shown at 308. The network shows by the connection 340 that the project manager (people node 304) who created the current project node 302 acted as a subject matter expert (SME) in the project represented by the project node 308. The project node 308 includes additional connections (312, 316, 320, 324) to other nodes (310, 314, 318, 322). That is, project node 308 has another SME connection 312 to a people node 310, representing that the person represented by the people node 310 also acted as a subject matter expert in the project represented by the project node 308. The project node 308 is also connected with a work product 314, a security roles presentation (e.g., a chart). The link 316 connecting the project node 308 and the work product node 314 specifies a “created on” type. The project node 308 is also connected to another work product node 318, an on-boarding presentation, with a link 320 of type “created on.” The project node 308 has another connection to yet another project node 322 as shown by the link 324.

The project node 322 has a link 330 to work product node 328, which for example may be a workshop transcript. The project node 322 also has a link 334 to another work product node 332, which for example, is shown as workshop checklist. The project node 322 is further connected as shown by the SME link 338 to a subject matter expert represented by the people profile 336. The link 326 illustrate that the work product 318 was used in both projects of nodes 322 and 308.

The nodes shown in FIG. 3A includes project node, people node, and work product node. Other types of nodes are possible. Each node includes information about the item or people that the node represents. For instance, people node may include information such as the person's name, title, expertise and/or skill set, location, and other information about the person. Project node may include information about the project the node is representing, for example, project title, project type, the client for whom the project is being built, industry sector of the client or the project, dates such as start date and milestone dates, and other information. Work product node may include information about that particular work product. A work product node may have actual content of the work product, for example, the documents as pdf files or in other formats, or a hyperlink to memory storage location to where the work product is stored. Work products may include presentation charts, work documents, and others. The nodes of the network may be directly connected or indirectly connected via other nodes.

FIG. 3B shows the example network of FIG. 3A with project to project connections being created, for instance, as a result of a recommendation suggested automatically by the network-analysis module and/or manually by a user. The network-analysis module may have made the recommendation based on its automatic analysis, for example, determining that the project of node 322 has some aspects of the projects which are in common with the current project of node 302, for instance, by determining that both projects are related to automobile industry sector and/or other common features. The connection 342 is recommended so that, for example, the current project at node 302 may share or use one or more of the people or work products that were involved in the project represented by the project node 322. A user may also manually make the connections between the nodes as shown by the link at 344. For instance, the project manager represented by the people node 304 may know that he or she acted as a subject matter expert in the project of node 308 and therefore, manually connect the two nodes. In one aspect, a user interface module at the client or web browser may allow the connections to be entered manually.

FIG. 3C illustrates possible one or more team members or participants being identified to work on the current project represented by the project node 302. The network-analysis module or the like may automatically analyze and information in the nodes of the network and provide recommendations. For instance, a person at people node 336 may be recommended and link 346 created, for example, as a result of the network-analysis module determining that that person has the skills or expertise that may be needed in the project of project node 346. A user may manually create a connection as shown at link 348 to a person represented by people node, for instance, by using the user's own knowledge, for example, the project manager of the current project was a subject matter expert on project of project node 308 and knew another subject matter expert (represented by people node 310) in that project (project node 308).

FIG. 3D illustrates work products that may be used in the current project being identified and being cleansed before using them. For instance, the cleansing module or the like of the present disclosure may hide or protect confidential or other information that should remain private, in the data of the project nodes 308, 322 and work product nodes 314, 318, 328, 332. For instance, some of the links and contents are hidden or masks in FIG. 3D as compare to the nodes and links in FIG. 3C. FIG. 3D also shows an owner node connected to the project node 302 to indicate the ownership of the current project.

The project network of the present disclosure presents model-based nodes (e.g., projects, people, and work products) and model-base links (e.g., project to project, project to people, project to work products, people to work products) and allow for sharing of information beyond the local project. Such network of nodes or profiles may be presented or displayed on a client or user interface as graphics.

In another aspect, the network analysis module 212 may analyze the information in the project network database 208 to determine various metrics associated with the projects. For instance, the following metrics and other may be identified in assisting in project scoping and creation.

Betweenness: The extent to which a node lies between other nodes in the network. This measure takes into account the connectivity of the node's neighbors, giving a higher value for nodes which bridge clusters. The measure reflects the number of people (or other nodes) who a person is connecting indirectly through their direct links.

Bridge: An edge (i.e., the link that connects two nodes) is said to be a bridge if deleting it would cause its endpoints to lie in different components of a graph.

Centrality: This measure gives a rough indication of the social power of a node based on how well they “connect” the network. “Betweenness”, “Closeness”, and “Degree” are all measures of centrality.

Closeness: The degree an individual (or a node) is near all other individuals in a network (directly or indirectly). It reflects the ability to access information through the “grapevine” of network members. Thus, closeness is the inverse of the sum of the shortest distances between each individual and every other person in the network.

Clustering coefficient: A measure of the likelihood that two associates of a node are associates themselves. A higher clustering coefficient indicates a greater ‘cliquishness’.

Cohesion: The degree to which actors are connected directly to each other by cohesive bonds. Groups are identified as ‘cliques’ if every individual is directly tied to every other individual, ‘social circles’ if there is less stringency of direct contact, which is imprecise, or as structurally cohesive blocks if precision is wanted.

Degree: The count of the number of ties to other actors in the network. This may also be known as the “geodesic distance”.

(Individual-level) Density: The degree a respondent's ties know one another/ proportion of ties among an individual's nominees. Network or global-level density is the proportion of ties in a network relative to the total number possible (sparse versus dense networks).

Flow betweenness centrality: The degree that a node contributes to sum of maximum flow between all pairs of nodes (not that node).

Path Length: The distances between pairs of nodes in the network. Average path-length is the average of these distances between all pairs of nodes.

Prestige: In a directed graph prestige is the term used to describe a node's centrality.

Radiality: Degree an individual's network reaches out into the network and provides novel information and influence.

Reach: The degree any member of a network can reach other members of the network.

Structural cohesion: The minimum number of members who, if removed from a group, would disconnect the group.

Structural equivalence: Refers to the extent to which nodes have a common set of linkages to other nodes in the system. The nodes do not need to have any ties to each other to be structurally equivalent.

Structural hole: Static holes that can be strategically filled by connecting one or more links to link together other points. Linked to ideas of social capital: if one person links to two people who are not linked, the one person can control their communication.

Metrics such as centrality and density may be used in identifying the best practice projects whose assets are known for high quality. Also, metrics like closeness and clustering coefficient may be used in relational learning, link prediction, nearest neighbor search, and other, for instance, described with reference to FIG. 1 at 106.

The model-based-ness employed in the present disclosure in one aspect allows the non-human entities, i.e., projects, to be represented in the network, and also allows for more autonomous way of stating the goals of projects and responding to demands of other entities in the network. The model-based-ness also allows exploiting of a richer feature-space to cluster and match entities on the network. This clustering (based on the model provided feature space) may predict networking possibilities. Social-structure and interdependencies based on the Packaged Applications domain may be also provided. For example, Industries, Business Process Hierarchies, and packaged-components may be leveraged to specify a social structure. Depending on the relationships that a Project entity has with respect to these, it can be placed accordingly in a social structure and used in relating it to other projects. Further, metrics in social network analysis customized for Packaged Application Practice Networking may be provided.

The network of projects, people and work products may be utilized to identify best practices for running a project, extend the impact of a project beyond its lifetime, and provide an infrastructure for dissemination information.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

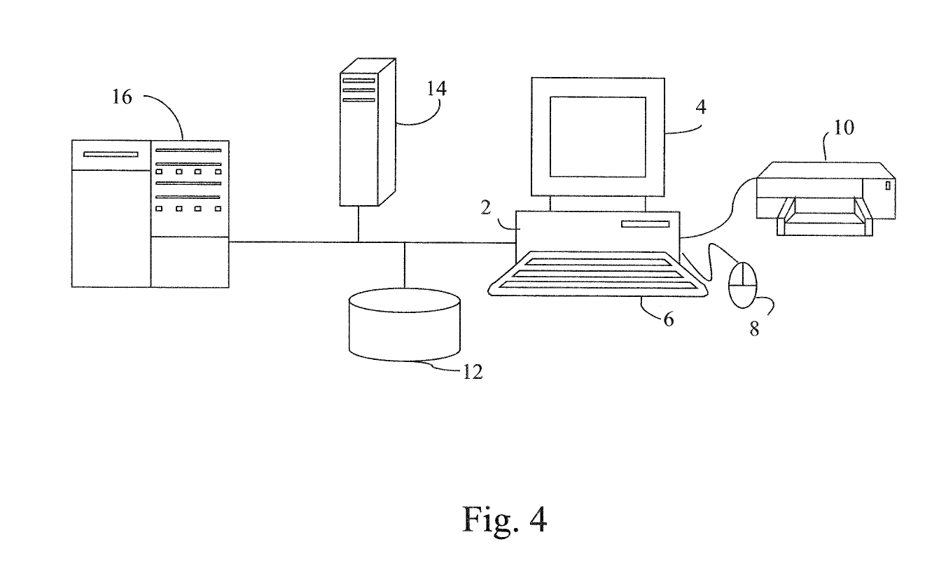

Referring now to FIG. 4, the systems and methodologies of the present disclosure may be carried out or executed in a computer system 2 that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 4 for presenting output displays and providing a display through which the user may input data and interact with the processing system, for instance, in cooperation with input devices such as the keyboard 6 and mouse device 8 or pointing device. The computer processing system may be also connected or coupled to one or more peripheral devices such as the printer 10, scanner (not shown), speaker, and any other devices, directly or via remote connections. The computer processing system may be connected or coupled to one or more other processing systems such as a server 10, other remote computer processing system 14, network storage devices 12, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 2, 14, 16), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for managing a model-based project network, comprising:
a processor;
a network creation module operable to create one or more project profiles, one or more people profiles, and one or more work product profiles, and to create a plurality of links among said one or more project profiles, said one or more people profiles, and said one or more work product profiles;
a profile database operable to store said one or more project profiles, said one or more people profiles, and said one or more work product profiles, and to store said plurality of links among said one or more project profiles, said one or more people profiles, and said one or more work product profiles; and
a network analysis module operable to analyze data stored in the profile database and recommend one or more people, work products and projects that are related.

2. The system of claim 1, wherein the network analysis module is operable to recommend one or more work products that are determined to have been used together.

3. The system of claim 1, further including:
an asset cleanser module operable to hide confidential data in said one or more project profiles, said one or more people profiles, said one or more work product profiles, and said plurality of links before presenting information associated with said one or more project profiles, said one or more people profiles, said one or more work product profiles, and said plurality of links to one or more users.

4. The system of claim 1, further including:
a user interface module operable to enable one or more users to enter information for creating said one or more project files, said one or more people profiles, and said one or more work product profiles.

5. The system of claim 4, wherein the user interface module is operable to display a network of said one or more project profiles, said one or more people profiles, and said one or more work product profiles, and said plurality of links among said one or more project profiles, said one or more people profiles, and said one or more work product profiles.

6. The system of claim 1, wherein said one or more work products include documents, computer program code, presentations, audio, video, meeting minutes, calendars, and checklists.

7. The system of claim 1, further including:
an asset repository operable to store one or more work products associated with said one or more work product profiles.

8. A method for managing a model-based project network, comprising:
creating, using a processor, a project profile that includes information associated with a project;
identifying a people profile associated with a possible participant for the project by searching a database of profiles and analyzing data stored in the database of profiles;
identifying a work product profile from the database of profiles for use in the project based on the data stored in the database of profiles, the work product profile including information associated a work product and work product content;
creating a project-to-people link between the project profile and the identified people profile; and
creating a project-to-work product link between the project profile and the identified work product profile.

9. The method of claim 8, wherein the identifying of a work product profile and the identifying of a people profile are performed by searching the profile database and determining an existing project profile related to the project profile and following one or more links from the existing project profile to one or more work products and one or more people.

10. The method of claim 8, further including:
recommending the identified work product profile to a user before performing the creating the project to work product link.

11. The method of claim 8, further including:
recommending the identified people profile to a user before performing the creating of the project to people link.

12. The method of claim 8, further including:
identifying an existing project profile in the profile database potentially related to the project, and creating a project to project link between the identified existing project profile and the project profile.

13. The method of claim 8, further including:
enabling a user to manually create one or more project to project links, one or more project to people links, one or more project to work product links, or combinations thereof.

14. A computer readable storage medium storing a program of instructions executable by a machine to perform a method for managing a model-based project network, comprising:
creating, using a processor, a project profile that includes information associated with a project;
identifying a people profile associated with a possible participant for the project by searching a database of profiles and analyzing data stored in the database of profiles;
identifying a work product profile from the database of profiles for use in the project based on the data stored in the database of profiles, the work product profile including information associated a work product and work product content;
creating a project to people link between the project profile and the identified people profile; and
creating a project to work product link between the project profile and the identified work product profile.

15. The computer readable storage medium of claim 14, wherein the identifying of a work product profile and the identifying of a people profile are performed by searching the profile database and determining an existing project profile related to the project profile and following one or more links from the existing project profile to one or more work products and one or more people.

16. The computer readable storage medium of claim 14, further including:
recommending the identified work product profile a user before performing the creating the project to work product link.

17. The computer readable storage medium of claim 14, further including:
recommending the identified people profile a user before performing the creating of the project to people link.

18. The computer readable storage medium of claim 14, further including:
identifying an existing project profile in the profile database potentially related to the project, and creating a project to project link between the identified existing project profile and the project profile.

19. The computer readable storage medium of claim 14, further including:
enabling a user to manually create one or more project to project links, one or more project to people links, one or more project to work product links, or combinations thereof.

20. The computer readable storage medium of claim 14, further including:
computing one or more metrics associates with a network of profiles formed from a plurality of project profiles, a plurality of work product profiles and a plurality of people profiles and plurality of links among said plurality of project profiles, said plurality of work product profiles and said plurality of people profiles.
